(19) United States
(12) Patent Application Publication
(10) Pub. No.: US 2004/0205043 A1
(43) Pub. Date: Oct. 14, 2004

(54) Identification and documentation of accesses to a communication network

(76) Inventors: Marzio Alessi, Torino (IT); Eugenio Guarene, Torino (IT); Federico Renon, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/480,858

(22) PCT Filed: Jun. 27, 2002
(86) PCT No.: PCT/IT02/00426

(30) Foreign Application Priority Data
Jun. 29, 2001 (IT) TO2001A000630

(51) Int. Cl. G06F 7/00; G06F 17/30

(52) U.S. Cl. 707/2

(57) ABSTRACT

The system includes a first database (DB1i) that collects first data relating to the access of customers to networks which envisage authentication, authorisation and accounting (AAA) procedures. The system makes also use of a plurality of cache memories (CDN), organised according to a Content Delivery Network architecture. The Log files of the cache memories (CDN) involved defines a second database (DB2) containing access data relating to the network access modalities from the users and to the relating content to which the users had access. A data acquisition block (1) interworks with the above cited databases, DB1i, DB2, so as to generate access documentation reports (R1, R2,) capable of identifying the users having access to the network in a correlated way and to the network content they have accessed. A preferential application to the production of customised reports for Content Providers (CP.), Internet Service Provides (ISP) and/or users/clients (C).

### TECHNICAL FIELD

The present invention is related to a system for the identification and documentation of accesses to a data communication network, such as for instance the internet network.

The invention was conceived with particular attention to the possible use in situations whereby an Internet Service Provider (ISP) implements a so called Content Delivery Network) (CND) in order to supply all the Content Providers involved with an effective content delivery distribution.

The invention, also, is related to the possibility for a Network Provider of implementing a Content Delivery Network and selling in turn effective content delivery distribution services to ISPs, which instead only provide the network service access.

### BACKGROUND ART

As is well known, an Internet Service Provider is an entity offering users a given type of Internet access (via modem, ISDN, ADSL, wireless, and so on). Said access exploits network infrastructures either owned by the same ISP or by a third economic party (usually called Network Service Provider or Network Provider).

An ISP allows users to have access starting from the so called Points of Presence (PoP) where calls are terminated, recorded and authorised (This is made possible through authentication, authorisation and accounting (AAA) procedures, based for instance on a RADIUS type server, and typically through the so called Network Access Servers (NAS). Furthermore, the access network is here connected to the local network backbone, thus to the Internet network. This is obtained in particular through subsequent connections of the local backbone to all the other world-wide backbones owned, for example by a Network Provider.

A Network Provider is an entity that has at its disposal a physical network infrastructure capable of ensuring adequate connectivity within a rather wide territory (typically of a state or even international size).

A Content Provider (CP) is in general the owner of the information content, i.e. the party whose task is to distribute information over Internet. Therefore, a Content Provider controls the servers that are typically deployed at an individual geographic location, having at the most local redundancy. The content items may be of different types and classified according to the application protocol governing their transfer and control. Typical examples thereof are the HTTP protocol (used for web pages), the FTP protocol (used for file transfer), the MMS or RTSP protocol (used for the live or on demand streaming for the transfer of video-audio clips). The streaming flows require the transfer of broader bands as compared to other applications and are therefore more burdensome from the distribution standpoint.

The Content Delivery Network architecture makes it possible in practice to save all the band otherwise used to cover the geographic distance between a client and the server of origin. Said architecture is therefore particularly effective for the distribution of all types of content and in particular for those with streaming.

### DISCLOSURE OF THE INVENTION

The present invention addresses in general the problem of performing—in a simple and effective way—the identification and documentation of customers' accesses to content items available on a data communication network such as Internet. The capability of carrying out such an action is important with a view of developing those techniques that allow the distribution over Internet of services subject to a selective billing, for instance, depending on the nature and content of the data being supplied, on the time intervals and the time bands during which such services have been provided, etc. The possibility of identifying and documenting the access to the network is also important in order to carry out statistics on access data, including ratings on services being supplied.

All this is obtained by assuring compliance with any privacy requirements for which users show an ever increasing sensitivity.

According to the present invention, this aim is attained through a system having the characteristics specifically recalled in the following claims.

### BRIEF DESCRIPTION OF DRAWINGS

The invention will now be described purely by way of a non—limiting example, with reference to the appended drawings, wherein:

FIG. 1 depicts in purposely schematic terms the general principle on which the solution according to the present invention is based;

FIG. 2 depicts in the form of a functional block diagram a first possible architecture of a system according to the invention;

FIG. 2a depicts in the form of a functional block diagram a second possible architecture of a system according to the invention;

FIG. 3 depicts a possible embodiment of the block diagram of FIG. 2,

FIG. 4 shows the logic diagram of the information processing procedure within a system according to the invention; and

FIGS. 5 and 6 show two examples of reports to be issued in a system according to the invention.

### BEST MODE FOR CARRYING OUT THE INVENTION

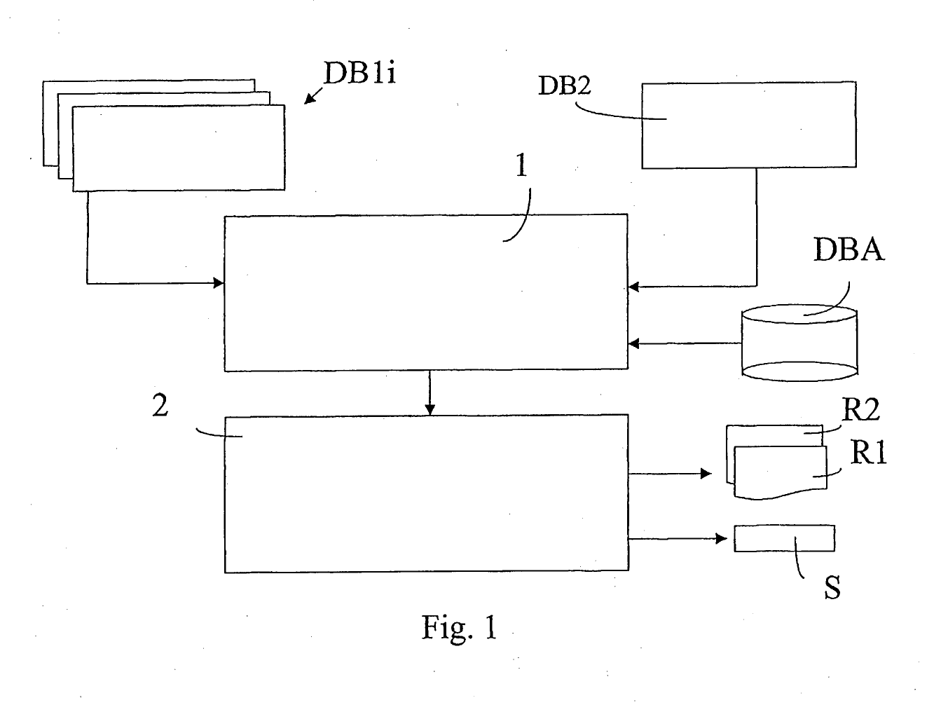

In essence, the invention is based on the fact that each Internet Service Provider has its own authentication, authorisation and accounting (AAA) system for all the clients accessing Internet through it. In the most used embodiment, such an AAA system is implemented by a so-called RADIUS server (there is typically a centralised server for each ISP). The RADIUS server—whose naming so as applied within this description and in the following claims, shall be obviously meant as inclusive of any possible, future evolutions of the RADIUS standard—gathers within a database DB1i (FIG. 1) all information on the Internet connections of each client.

According to the example the index “i” associated to DB1 represents an index identifying an Internet Service Provider being the owner of the same data base.

The client data typically arrive from the various Network Access Servers (NAS) located at the PoPs of the geographic area covered by the “i” ISP under question. The NAS servers substantially are the servers where calls are terminated; among other things, they assign IF addresses to all the clients requesting to be connected and that are authenticated. Database DB1i of a RADIUS server contains also the clients' personal data to be used for billing. In essence, DB1i of RADIUS server contains, for each ISP, information such as the IP addresses of the client that has made the individual connection, connection start and end time, first name, last name, user's name, telephone number of the calling party, address, etc.

Similarly, a data network using a Content Delivery Network architecture envisages the use of various cache memories located at the different PoPs of the ISP involved. In addition to their main functionality, i.e. retrieving and storing (or “cacharing”, according to a sometimes used jargon), of the content of the server of origin of the Content Providers enabled to the CDN use, the cache memories under question are able to hold, through own Log Files, information on the activity of the users having access to the types of content dealt with by the Content Delivery Network.

The set of the above-cited Log Files may therefore be regarded as forming on the whole a second database DB2, distributed whenever necessary over the territory where for the different types of distributed content (HTTP, live and on-demand streaming, etc), data are available, such as name of the requested object (for instance, clip: www.cnn.com/video.asf), the application protocol used (for instance MMS), IP addresses of the calling client, request time, any pause, rewind forward actions, etc.

So as schematically depicted in FIG. 1, the approach according to the present invention envisages the generation of an integrated set of data starting from databases DB1i and DB2.

This is performed through a data selection and acquisition block, denoted by 1 as a whole, to which according to modalities specified in more detail in the sequel, a block is associated for issuing reports R1, R2, . . . On the basis of an input parameter introduced by the operator, block 1 first performs the selection of data base DB1i to be processed according to procedures described in the sequel. To do so, the block 1 holds and consults, for example, a table containing correspondences between PoP-cache and cache-PoP.

Moreover, block 1 generates and manages an additional database, DBA, into which the information contained as text files in database DB2, i.e. in the various Log Files of all the cache memories located at the different PoPs of the CDN, which is usually performed in real time and in a co-ordinated manner with the data contained in the selected database DB1i. As a matter of fact, the cache memories under question, denoted in the drawings for simplicity as CDN, are so configured as to send own Log Files (usually via HTTP or FTP, as text files) to a web server which implements in practice block 1. In particular, the server involved is so implemented as to share the disc with the work station (of a known type, using for instance UNIX) on which the identification and documentation database is installed. Thus, as will be better explained in the sequel, block 1 exploits its own database DBA by generating tables containing the fields of interest extrapolated from the text files recorded by the same machine.

Furthermore, database DBA of block 1 works in connection with database DB1i of RADIUS server, so as to supplement the fields of some of its own tables through the fields of interest derived from the database DB1i of RADIUS server. The tables thus generated are exploited by block 2 for the generation of reports R1, R2, . . . , S.

It should be noted that both databases DB1i and DB2 can be in general accessed at the service centre of the CDN implemented by the Internet Service Provider. As for the access to databases DB1i, this is typically obtained through:

Database links;

Synchronous Internet application with remote data access;

Data transfer and local loading.

Block 2 issues at its output reports R1, R2, . . . , produced for instance in HTML or XML format, obtained by using current development tools.

The output documentation of the system can be structured in such a way as to interface with commercial systems (for instance, billing or reporting systems). In this case the system simply generates some records (S) which the commercial systems downstream require at their input to perform their functionality.

The record format contains general registration data of the customer, details of the execution date of an action, type of action, quantity of resources involved by the action, action results, and service quality perceived by the customer. The scheduling frequency of the report is such that each individual action of any customer may be detected. Therefore, the system suggests a new definition of structure and scheduling frequency of the S records, such as to allow a billing system to charge the users' actions according to parameters to be derived from each individual record or from aggregations of said records, according to the various policies of the Network Providers or ISP.

Since the system provides details on the requested content, and the generation frequency of the records can be rather high, the system, according to the invention, can supports pre-paid billing modalities on a content basis.

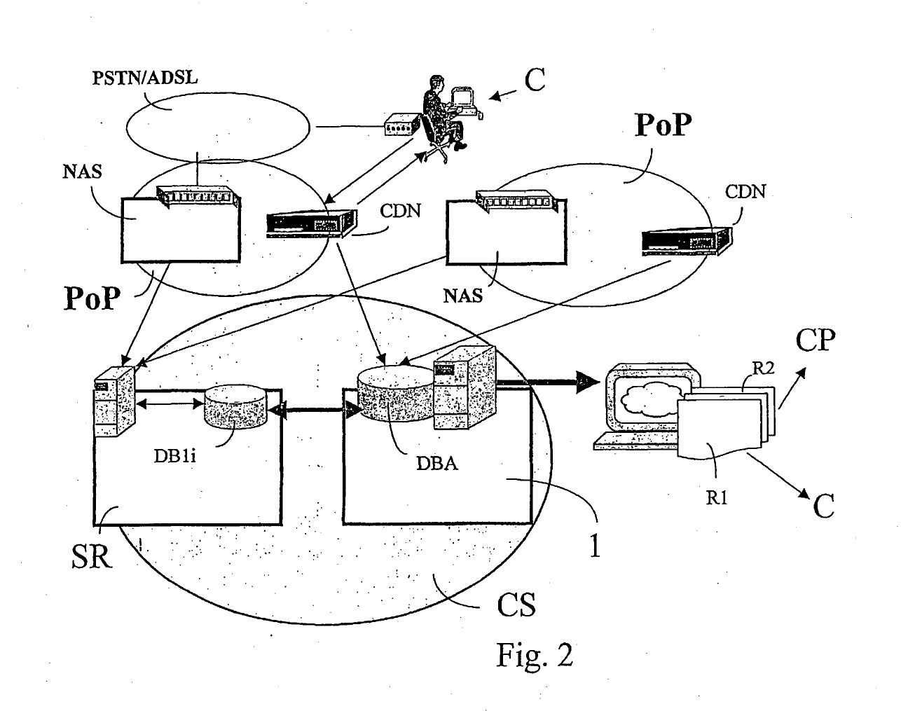

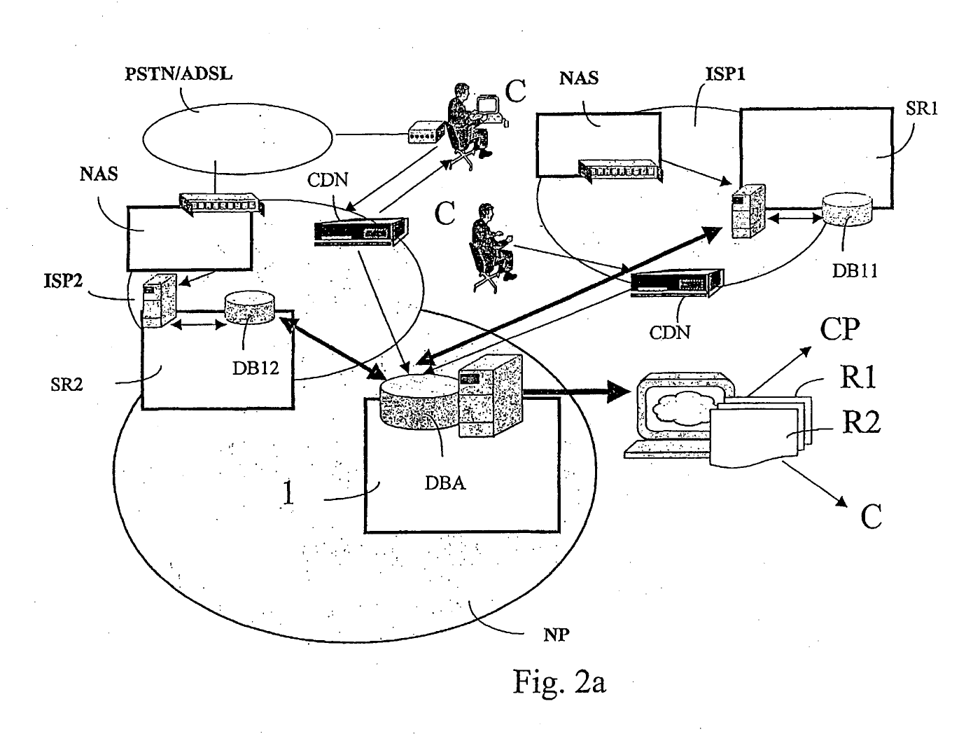

In FIG. 2 diagram, the number reference C denotes in general a user or a client having access to Internet (or to an equivalent data communication network), for instance over a PSTN/ADSL line. This is brought about through an appropriate Point of Presence (PoP); FIG. 2 diagram describes the case in which the network involved incorporates any number of PoPs.

The connection of user C to the corresponding PoP takes place in particular over the corresponding Network Access Server or NAS, and in the event of a network organised according to the Content Delivery Network (CDN) principles, this implies the pre-arrangement and intervention of a corresponding CDN cache.

The NAS servers of the different PoPs have to report to a RADIUS server SR, where the corresponding data banc denoted by DB1 is situated.

Furthermore, the approach according to the present invention envisages—usually at the same CS centre—the presence of block 1, with the aim of merging the data contained indatabase DB1 with data extracted from the different CDN caches (database DB2) so as to generate database DBA.

Data contained in such a database shall be processed by module 2, which has also the task of transmitting relating reports to the addressed parties. The latter may be for instance a Content Provider CP, the Internet Service Provider ISP or the same user C.

The latter case is particularly important as it allows user C for instance to control and check reports R1, R2, . . . , through the typical check procedures currently used for bills. At the same time the transmission of reports to the user C ensures the compliance with privacy requirements, in order to grant for instance that the holding and possible distribution of given information are subject to the express approval by user C.

FIG. 2a depicts a variation of the architecture described in FIG. 2, where a generic scenario is considered in which two ISP (ISP1 and ISP2) use the Content Delivery Network of a Network Provider (NP). A client C has access to the network service offered by ISP1. Others have access to the service offered by ISP2.

In this case the system is capable of documenting the accesses to the content distributed by CDN, respectively, through ISP1 or ISP1, having access to and selecting, respectively, the data SR1 or SR2 whose owner is, respectively, ISP1 or ISP2 and generating, according to what has been described, the data relating to the users, respectively, of ISP1 or ISP2.

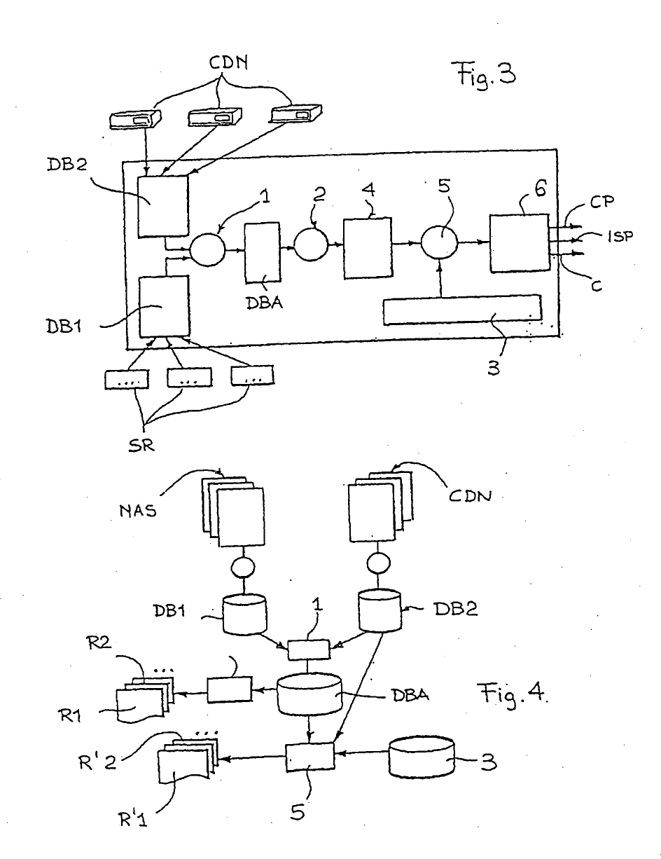

The block diagram of FIG. 3 substantially resemble the block diagram of FIG. 2 and 2a and serves to emphasise the possibility of using a system according to the invention for carrying out the billing procedures of a selective kind. This can be typically performed for instance as a function of the information content a given user has taken from the network through its various accesses over a predefined time period, as a function of the duration of accesses, as a function of the time bands during which accesses have taken place.

In the block diagram of FIG. 3, the functional elements already described in the previous part making reference to FIGS. 1, 2 and 2a (or equivalent elements) have been denoted by the same references and therefore they will no more be recalled in an explicit way.

FIG. 3 block diagram makes clear that block 2 which has the task of generating the reports, is capable of interacting with a module 3, whose task is the implementation of the billing policies, for instance, of a given Internet Service Provider ISP.

Block 2 produces at its output a documentation set 4 pertaining to the traffic developed by a given user and/or Content Provider. Said traffic data and details (the term “traffic” is here used in its widest meaning, inclusive of timing, duration, modalities, content types, different accesses) are merged, in a processing block 5, with the parametric data of the billing policies contained in module 5. All this is aimed at generating, as output 6, the corresponding billing data to be transmitted to user C, content provider CP and/or Internet Service Provider ISP.

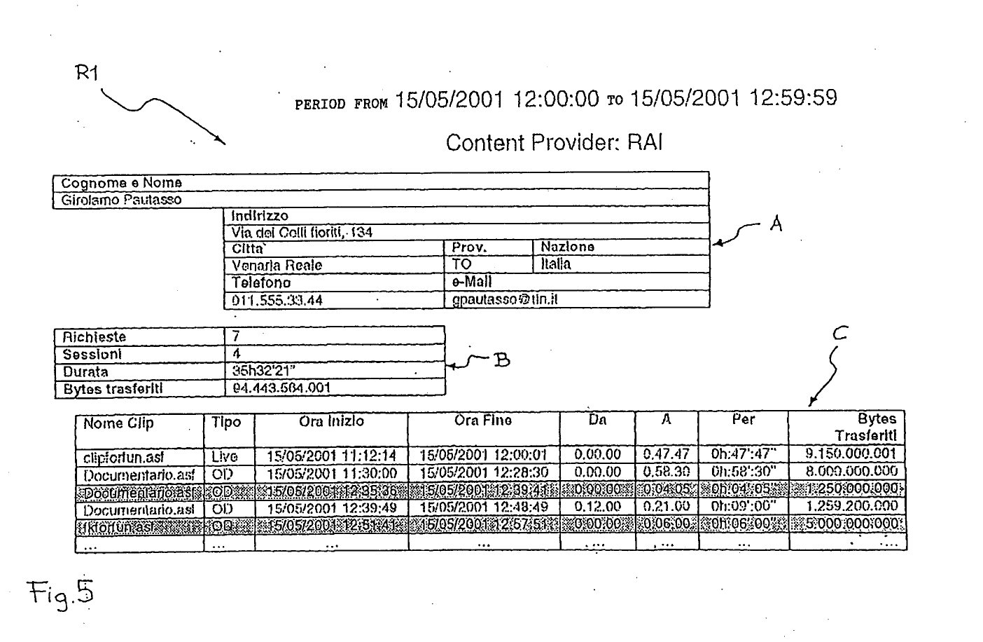

The diagram of FIG. 4 depicts once again the creation mechanism of the database DBA which is organised by block 1 starting from databases DB1 (data coming from the NAS server) and DB2 (data coming from CDN cache memories).

In addition to the possible generation of reports R1, R2, . . . , by block 2, the diagram of FIG. 4 shows the possibility for block 5, responsible for billing, to interact with database DBA, database DB2, as well as 3 of the billing system. All this will allow the generation of reports R′1, R′2, . . . , that properly qualify as “content billing reports”.

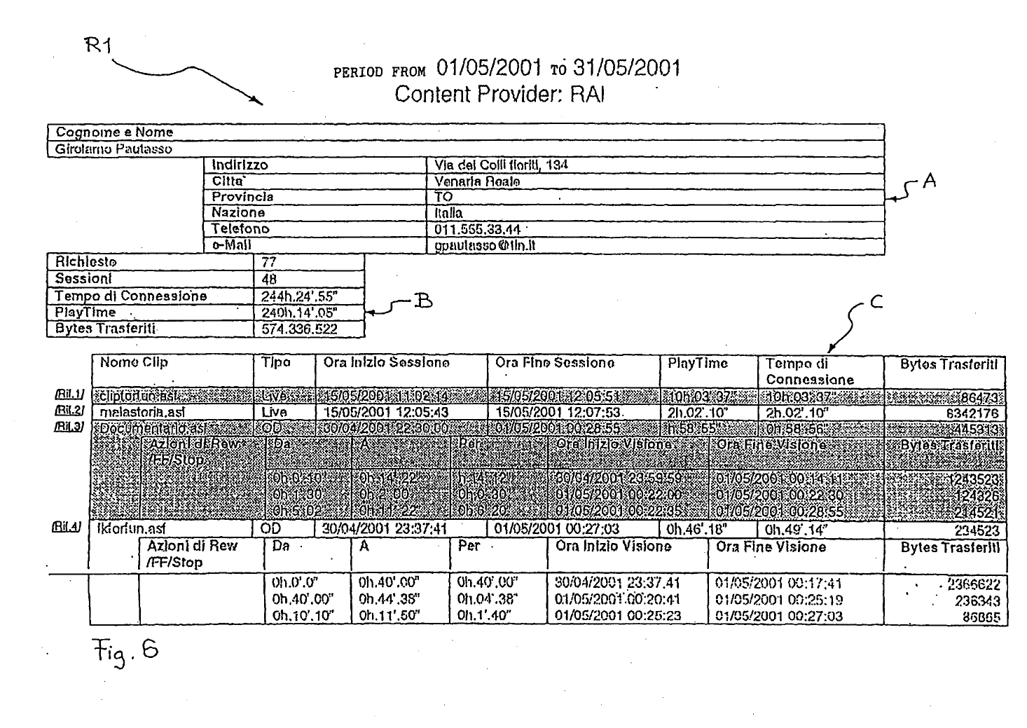

FIGS. 5 and 6 show two typical examples of report that may be generated in a system according to the invention.

Both examples refer to the customised reports for a given Content Provider CP, such as for instance a distribution company of audio-visual programmes. Each report refers in general to the access operations performed in a given time interval, shown on the report headings.

In general, such a report shows in real time the users with their registration data, as a function of their different requests.

In both reports shown in FIGS. 5 and 6, notation A indicates as a whole the set of registration data relating to the user (first name, last name, address, telephone number and e-mail address).

Reference B indicates instead a summarising data set of the traffic developed by the user involved (requests, sessions, total duration, transferred bytes).

It will be appreciated that in the case of FIG. 6 report the data concerning the overall duration of the connections are given in a disaggregated form making reference to the total connection time and play time.

Eventually, C denotes a data set concerning traffic, in a greater detail. For instance, in the case of FIG. 5, the various clips viewed by the user are listed giving clip name, type of the clip (if live or OD), start and end times of the same, start and end stages of the display, total duration and number of transferred bytes.

In the case of FIG. 6, even more details are given since documentation records are offered in a disaggregated form, of the viewing intervals between subsequent rewind, fast forward and stop actions.

It will be appreciated that the reports developed according to modalities described herein, may form am actual basis to apply for instance billing policies of a pre-paid type on a content basis, because the identification of all the actions performed by the user is carried out in real time. For each user the following details are given: number of requests, sessions, transferred bytes, total display time and, if necessary, further details on the clip segments displayed.

Likewise, the same reports may be used as a starting basis to perform billing policies of a “subscription type”, content based, since it is possible to generate for each user a list of the viewed clips, with details and actions performed. In particular, the procedure of data recording permits the additional documentation of the actions effected by the users on each clip requested.

Without considering the listing hereinafter as an exhaustive description of all the possible applications of the approach according to the present invention, we will now recall the following modalities of use for the reports issued within the system according to the present invention.

### Generation of Customised Statistics for Each Content Provider (CP), Listing all the Accesses as a Function of Requests Placed by the Users

For each requested object (as an example, clips viewed by the users are here being considered) the following data will be extracted: number of requests, users connected, total of transferred bytes, clip typology, total viewing time, and possible errors in the request/transmission procedure to underline successful requests. The data extraction procedure allows us to give further details on the information concerning the clips, by detecting for instance the requests as a function of a province and of a time band.

### Generation of AudiNet Type Reports on a Localised Basis (for Instance: State, Region, Province)

It is possible to issue share ratings of the most viewed clips during the day. The share is computed with respect to the total of requested clips.

A selectable sorting parameter is allowing the generation for instance of:

ratings of accesses,

ratings of transferred bytes,

ratings of viewing time,

ratings of the average band (ratio between transferred bytes and viewing time, indicative of the average transmission quality).

Obviously the above-indicated data may also be presented according to time bands (for instance, reports relating to all daily time bands) or on a daily basis (for instance, report relating to the total activity of a day).

It is also possible to compute the total share so as to assess a ratings parameter for the Content Provider.

### Generation of Reports According to Time Bands

The report customised for each Content Provider lists for any time band in a day the information relating to the transferred bytes, connection time, execution time, errors and average band. The viewing of the relating data may be effected on a daily, weekly and monthly basis.

### Error Lists Based on Individual Categories

The report customised for each Content provider generates a list of errors sorted according to each category. It is therefore possible to perform a monitoring of the CDN service efficiency, in addition to a wide range analysis concerning the error typology.

### Activities Sorted for Different Towns

The report customised for each Content Provider lists for each town of origin of the request, the information relating to the transferred bytes, connection time, performance time, errors and average band. The viewing of the data may be carried out on a daily, weekly or monthly basis.

### Effectiveness

The report customised for each Content Provider lists, for on demand content requests, the total number of bits in a day, and detects the percentage effectiveness of the CDN service. The viewing of data may be on a daily, weekly or monthly basis.

### Activities as Per Individual Week Day

The report customised for each Content Provider lists for each day of the week the information relating to the transferred bytes, connection time, execution time, errors and average band. The viewing of the data may be performed on the basis of a parametrised period.

### Activities on a Month Basis

The report customised for each Content Provider lists for the last 12 months the information relating to the transferred bytes, connection time, execution time, errors and average band. The viewing of the data may be performed according to a parametrised period.

### List of Clips as Per Average Play Time

The report customised for each Content Provider lists for each clip the number of requests, the average time of execution and connection.

The viewing of the data may be performed according to a parametrised period.

### List of Errors as Per Category

The report customised for each Content Provider provides a monthly statistics of failed bits with regard to on-demand content requests and the relating successful ratio.

### Transferred Packets Per Individual Clip

The report customised for each Content Provider provides, for each clip, information about packets that have been transmitted, received, or re-transmitted, if any.

Obviously, leaving unchanged the principle of the invention, implementation details and practical embodiments may be considerably varied with regard to what has been herein described and depicted, without departing from the scope of the present invention.

1. System for the identification and documentation of accesses to a data communication network, characterised in that it incorporates:
at least one database (DB1i) for collecting first access data, identifying the users having access to the network;
a plurality of cache memories (CDN) organised according to a Content Delivery Network architecture, with associated respective Log Files, defining a second database (DB2) directed to collect second access data identifying the access modalities to the network by said users and the network content to which said users have access;
a data acquisition block (1) capable of interacting with said first database (DB1) and said second database (DB2) and of correlating among them said first and said second access data, so as to generate documentation reports concerning the access to the network (R1, R2, . . . ) in order o identify the users accessing the network, the access modalities to the network by said users, and the network content to which said users have access.

2. System according to claim 1, characterised in that said at least one database (DB1i) is so configured as to collect access data of users having access to the network through-an-authentication, authorisation and accounting (AAA) procedure.

3. System according to claim 1, characterised in that said at least one database (DB1i) is so configured as to collect first data relating to the users selected within the group formed by:
IP address of the user,
connection start time
connection end time
registration data of the user
user's username
telephone number of the calling party
address.

4. System according to claim 1, characterised in that said at least one database (DB1i) is served by a server of RADIUS type.

5. System according to claim 1, characterised in that said Log Files are so configured as to collect second data selected within the group formed by:
types of content of the access,
name of the requested object,
application protocol being used
IP address of the requesting party
Request time
Pause, rewind and forward actions.

6. System according to claim 1, characterised in that said data acquisition block (1) has associated a respective database (DBA) and in that said data acquisition block (1) introduces in real time into said associated database (DBA) the information contained as a text File in said Log Files of said cache memories (CDN)

7. System according to claim 1, characterised in that said cache memories (CON) are so configured as to send their own Log Files as text files via HTTP toward said data acquisition block (1).

8. System according to claim 1, characterised in that said acquisition block (1) is implemented through a respective web server that shares the disc with the work station on which there is installed a respective database (DBA) associated with said data acquisition block.

9. System according to claim 1, characterised in that said data acquisition block (1) has associated a respective database (DBA) containing respective tables and in that said associated database (DBA) of said data acquisition block (1) interacts with said first database (DB1) so as to supplement said tables through respective data derived from the tables of said first database (DB1)

10. System according to claim 1, characterised in that said data acquisition block (1) has associated a block for report generation (2), so configured s to generate said reports in HTML or XML format.

11. System according to claim 1, characterised in that said at least one database (DB1i) identifies an Internet Service Provider.

12. Method for the identification and documentation of accesses to a data communication network characterised by the steps of
identifying at least one data base (DB1i) collecting first information associated to a user accessing the network;
identifying a second data base (DB2) collecting second information associated to accesses by said user to at least me cache memory;
generating documentation reports concerning the access to the network (R1, R2, . . . ) by automatically correlating said first information with said second information.
